(19) United States
(12) Patent Application Publication
(10) Pub. No.: US 2002/0189429 A1
(43) Pub. Date: Dec. 19, 2002

(54) Portable digital music player with synchronized recording and display

(76) Inventors: Ziqiang Qian, Barrington, IL (US); Randy J. Cavaiani, Kildeer, IL (US); Aimee Volanski, Chicago, IL (US); Timothy M. Johnson, Alongquin, IL (US)

Correspondence Address: Adam K. Sacharoff, Hamman & Benn, 10 South LaSalle Street, Chicago, IL, 60603, US

(21) Appl. No.: 10/166,915

(22) Filed: Jun. 11, 2002

Related U.S. Application Data
(60) Provisional application No. 60/299,001, filed on Jun. 18, 2001.

(51) Int. Cl. G10H 1/26; G10H 1/36

(52) U.S. Cl. 84/610

(57) ABSTRACT

The present invention is directed to a digital portable music player that includes a non volatile memory for storing and recording music files. Where at least one of the music files includes at least an audio portion and a data portion. The player includes both a display screen for displaying the data portion and a headphone jack for receiving headphones such that a user may hear the audio portion. The player yet further includes a microphone jack for receiving an external microphone. A microprocessor is included that has instructions for retrieving and decoding said one music file from the non volatile memory and instructions for playing the music file. Wherein the instructions for playing the music file include instructions for displaying the data portion over the display screen simultaneously with emitting the audio portion over headphones. The microprocessor has further instructions for recording a user's voice, coming through the external microphone, in real time with the playing of the music file. The microprocessor has yet further instructions for synchronously replaying the recorded user's voice with said one music file at a later time.

### CROSS-REFERENCE TO RELATED APPLICATIONS

This application claims the benefit of U.S. Provisional Patent Application having Ser. No. 60/299,001 and filed on Jun. 18, 2001 and hereby incorporates the provisional application by reference.

### FIELD OF THE INVENTION

The present invention relates to portable digital music players and, more particularly, to the synchronized recording and outputting of a user singing with pre-recorded digital music.

### BACKGROUND OF THE INVENTION

Karaoke is a musical performance method in which a person (i.e., the singer) performs a musical number by singing along with a pre-recorded song through the reading of that particular song's lyrics, which are preferably displayed on a display device, such as, for example, a television screen situated within view of the singer. The singer's voice overrides the voice of the original singer of the pre-recorded song. A video motion picture, often referred to as a music video, may also be displayed as an accompaniment to both the music and the lyrics. Devices providing this opportunity are known as karaoke musical reproduction devices, and will be referred to as karaoke devices.

Current karaoke devices use tapes, compact disks (CDs), digital videodisks (DVDs), computer disks, video compact disks (VCDs) or any other type of electronic medium to record and play both the music and the lyrics. With the rise in popularity of karaoke as an entertainment means, more and more songs are put in karaoke format, meaning a format in which music without the original singing voice. In some instances, digitized data representing the music and data or text representing the lyrics have been compressed using standard digital compression techniques.

For example, one popular current digital compression technique employs the standard compression algorithm known as Musical Instrument Digital Interface (MIDI). U.S. Pat. No. 5,648,628 discloses a device that combines music and lyrics for the purpose of karaoke. The device in the '628 Patent uses the standard MIDI format with a changeable cartridge which stores the MIDI files. Other digital compression techniques that are known are produced under the International Organization for Standardization (ISO/IEC) for the coding of motion pictures and associated audio data. This standard is referred to as the MPEG (Motion Picture Experts Group) standard. The MPEG standard is defined in documents ISO/IEC 11 172 (which defines the MPEG 1 standard) 10 and ISO/IEC 13818 (which defines the MPEG 2 standard). Another popular, compression algorithm, which is based on the MPEG 1 and MPEG 2 standards, is referred to as MPEG 2.5, which utilize the compression standard of MPEG but at a different sampling rate and bit rate than the standards recommend for MPEG 1 and MPEG 2.

While typical karaoke devices are large, complex expensive systems used in bars and nightclubs. They involve large display screens, high fidelity sound systems and a multitude of storage media, such as, for example, CDs. Digital devices, such as MIDI and MP3 players are small, handheld portable devices. Typical digital players are small and affordable, but are designed to simply play music. They have small display screens to display only the title and play time of a song and limited audio output to a headphone.

Typical digital players do not currently possess the ability to record a users voice and then playback the users voice in sync with the pre-recorded music. Accordingly, it would be desirable to have a portable device and method that overcomes the above disadvantages.

### SUMMARY OF THE INVENTION

In accordance with the present invention a digital portable music player is provided that includes a non volatile memory for storing and recording music files. Where at least one of the music files includes at least an audio portion and a data portion. The player includes both a display screen for displaying the data portion and a headphone jack for receiving headphones such that a user may hear the audio portion. The player yet further includes a microphone jack for receiving an external microphone. A microprocessor is included that has instructions for retrieving and decoding said one music file from the non volatile memory and instructions for playing the music file. Wherein the instructions for playing the music file include instructions for displaying the data portion over the display screen simultaneously with emitting the audio portion over headphones. The microprocessor has further instructions for recording a user's voice, coming through the external microphone, in real time with the playing of the music file. The microprocessor has yet further instructions for synchronously replaying the recorded user's voice with said one music file at a later time.

This karaoke style permits a user to record their voice only and replay their recorded voice with the music file at a later time. The user may also be able to hear their voice through the headphone while they are singing. The portable player further permits normal playing of music files. The music files that are designed for this style will include a data portion that includes the lyrics of the song. The lyrics are thus displayed on the screen for the user to read. The lyrics typically scroll across the screen however, this aspect is not critical to the invention.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a block diagram a digital portable music player in accordance with the present invention;

FIG. 2 is a block diagram of the recording functions of the digital portable music player such that the user's singing is recorded to the non-volatile memory and played through the headphones simultaneously with the audio portion of the digital music file while the user is signing;

FIG. 3 is a block diagram illustrating a playback function of the digital portable music player that replays the recorded real digital audio signal simultaneously with the audio portion of the digital music file; and

FIG. 4 is a front view of a portable digital music player in accordance with a single embodiment of the present invention.

### DETAILED DESCRIPTION OF THE EMBODIMENTS

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

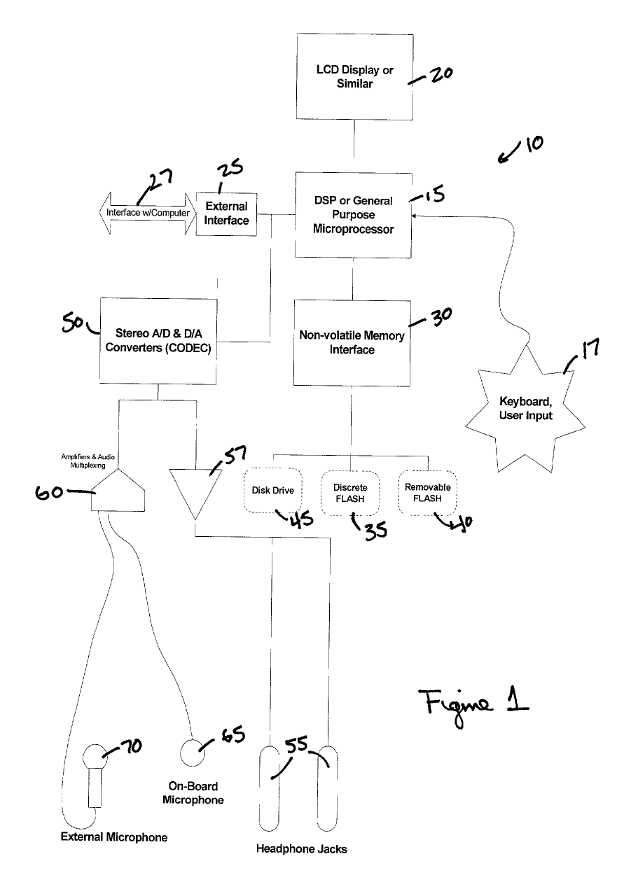

Referring now to FIG. 1. The architecture for a portable digital music player 10 enabled for the present invention is illustrated. The digital music player 10 includes a microprocessor 15 in communication with a LCD display screen 20. The microprocessor 15 includes an external interface 25 in order for the portable digital player 10 to interface 27 with a computer or outside source to download or receive digital music files. The microprocessor 15 would further receive and process any outside inputs for the user 17, such as control buttons or features on the portable digital music player 10.

The digital music file is stored in a non-volatile memory 30. The non-volatile memory interface 30 may interface with storage means that may further save the digital music files to an internal or discrete flash memory 35 and/or a removable flash memory 40. When the portable digital music player 10 includes the ability to receive removable flash memory 40 the music files may be pre-saved on the removable flash memory 40 prior to insertion into the player 10. Moreover the non-volatile memory interface 30 may interface with other external storage means, such as a disk drive 45 or even optical type drives.

The portable digital music player 10 includes a stereo a digital to analog converter or CODEC 50 to covert the digital signal to an analog signal, which permits the user to listen to the digital music file. The CODEC 50 is typically interfaced, via a headphone interfacing means 57, with headphones 55. In further accordance with the present invention the CODEC 50 would also include analog to digital converter means such that the user's voice may be recorded in digital form. The CODEC 50 would be attached to an amplifier and audio multiplexing means 60 that would allow the portable digital music player 10 to interface with an on-board microphone 65 and/or an external microphone 70, discussed in greater detail below.

During operation, a user would upload a digital music file into a non-volatile memory via interface 30. This could be accomplished by attaching the portable digital music player 10 to a computer by the computer interfacing means 27. For purposes of the present invention, the digital music file would typically include an audio portion, which includes only the music, and a data portion, which includes the lyrics of the song. The real singer's voice is left out of the digital music file. However, the portable digital music player 10 would play regular digital music files as well. The digital music file may also be uploaded to the player by the removable flash memory 40 or the disk drive 45. After uploading the music file, the user would play the digital music file. This is done by converting the digital audio portion to an analog signal and sending the analog signal to an audio amp or headphone interfacing means 57. The user is then able to listen to the audio portion or music through a pair of headphones 55. As with most portable digital music players 10, the digital music file may be compressed, for which the player 10 would decode the music prior to conversion to an analog signal.

The data portion, lyrics, will be displayed on the LCD display 20 such that it is in synchronous display with the music. The synchronized display of the lyrics is accomplished from the digital music file, meaning the portable digital music player will decode the digital music file an in accordance with any instructions within the music file will be able to display synchronized lyrics. The user watching the display screen 20 will be able to read and sing the lyrics in time with the music heard over the headphones 55.

Various options may now be presented for which the portable digital music player 10 may be capable of providing any or all of the options. The first option is referred to a “microphone on.” When an external microphone 70 is attached to the portable digital music player 10 through the amplifier and audio multiplexer 60, the portable digital music player 10 will simultaneously mix the audio from the microphone 70 with the output of the audio data of the digital music file. This permits the user to hear their voice over the headphone simultaneously when there are singing.

A second option that may be available is referred to a “recording on.” The portable digital music player 10 records the user's voice in real time and stores this “real audio” on a non-volatile memory via interface 30. The user may then select to play the real audio at a later time. It is important to note that the real audio that is recorded does not contain the audio data from the music as it only contains the user's voice and is recorded in real time. Since the audio data from the digital music file is replayed through the headphones, the external microphone would not record the audio data but only the real audio (user's voice). The non-volatile memory 30 would then contain the digital music file and a digital real audio file that corresponds thereto, which the user can play back together. During later playback both the digital music file and the digital real audio file would be mixed and sent to the headphones simultaneously. Similarly, the digital music file and the digital real audio file could be sent to a jack that attaches to an external stereo such that the files may be played on another device.

Another option would be to record the real audio, store the same on the non-volatile memory via interface 30, and permit a user to replay just the real audio without the audio music data. The real audio is converted to a real digital signal by the CODEC 50 and may even be encoded or compressed and stored on the non-volatile memory 30.

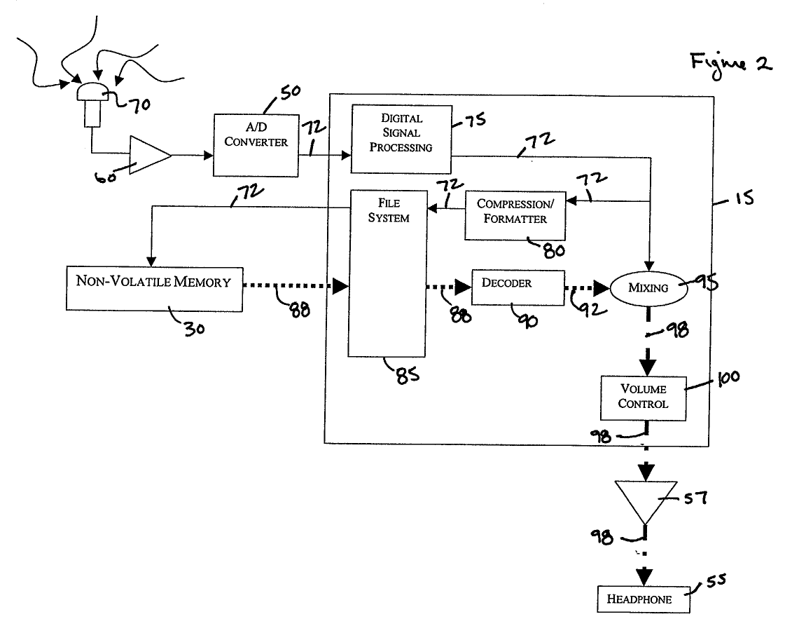

Referring now to FIG. 2, where the microphone 70 is receiving a user singing. The amplifier 60 sends the real audio signal to the analog to digital converter 50. The converter 50 converts the real audio signal into a digital real audio signal 72. The digital real audio signal 72 is then sent to the microprocessor 15, which may include the various processing and handling, such as a digital signal processing 75, a compression/formatter 80 and a file system 85. A digital signal processing 75 will processes the signal, such as spectral shaping, noise gating, automatic level control, echoing, delay and sampling rate as well as conversion. This filtering is done to make the digital real audio signal 72 into a more clear sound. The signal 72 is then sent to a compressor/formatter 80 that compresses and/or formats the digital real audio signal 72 into a pre-selected format that the portable digital music player uses. For example, if the portable digital music player is formatted for WMA files, the compressor/formatter 80 will format the digital real audio signal into a WMA file. Other formats may also be used such as ADPCM, MP3, MIDI, WAV, etc. If the portable digital music player decodes MP3 files, then the compression/formatter 80 will compress the digital real audio signal 72 into an MP3 file. The digital real audio signal 72 is then sent to a file system 85, which controls the location and storage of the signal 72 on a non-volatile memory via interface 30. Meanwhile, the file system 85 is pulling the digital music file 88 from the non-volatile memory 30 and sending the digital music file 88 to a decoder 90 that decodes the digital music file 88 into the audio portion and data portion. The audio portion 92 is sent to a mixing routine 95 that mixing the audio portion 92 with the digital real audio signal 72. The mixed signal 98 is then sent to a volume control 100 and to the CODEC 50 (not shown) and to the audio power amp 57 and then out to headphones 55. This permits the user to record the digital real audio signal 72 and hear it at the same time through the headphones 55, such that the user will hear themselves singing through the headphones 55 while they are singing. Also the data portion is being sent simultaneously to the display screen or LCD display 20.

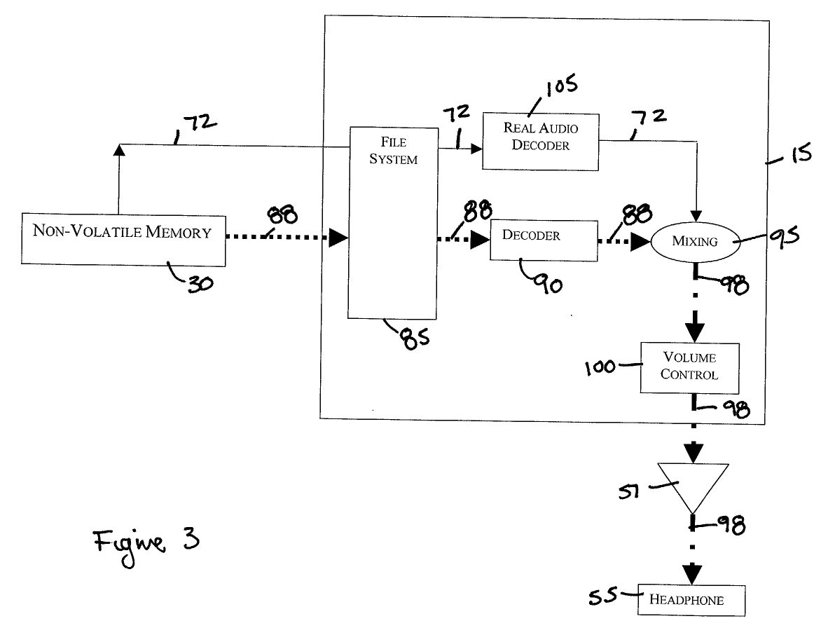

Referring now to FIG. 3, when the user wants to hear their recorded real digital audio signal 72 played simultaneously with the digital music file 88, the user makes the proper selection, discussed in greater detail below. The microprocessor 15 retrieves the two signals 72 and 88 from a non-volatile memory via interface 30. Both signals 72 and 88 are sent through the file system 85 to a means for decoding the signals. In the present invention, the decoding means includes two separate decoders, a first decoder 90 for decoding the digital music file 88 and a second decoder 105 for decoding the digital real audio signal 72. However, it is contemplated by the present invention that signal decoder may be used. After decoding the signals 72 and 88, the two decoded signals are sent to the mixing means 95 whereupon the digital real audio signal 72 is matched with the audio portion of the digital music file 88 such that the two signals are aligned and will broadcast or play simultaneously. Since the digital real audio signal 72 is recorded in real time, in order to synchronize the two, the digital real audio signal 72 is started at the same time the audio portion of the digital music file 88 is started. The mixed signal 98 may then be sent through a volume control 100 and eventually to the headphones 55, by passing through the CODEC 50 (not shown) and the headphone interface 57.

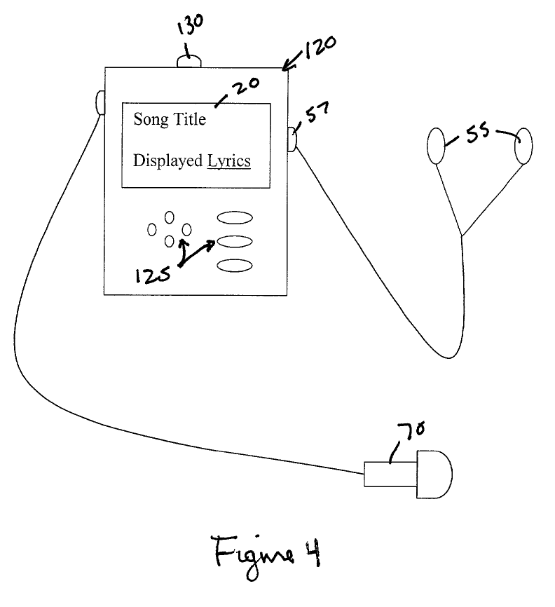

Referring to FIG. 4, an apparatus 120 is shown in but one embodiment of the present invention. While illustrated in FIG. 4, the device's appearance may be changed or altered without diverging from the spirit and scope of the present invention. The apparatus 120 includes a display screen 20 for which the data portion of the digital music file 88 is displayed. The apparatus 120 further includes headphones 55 that are interfaced with the apparatus 120 at the headphone interface or jack 57. The external microphone 70 is also interfaced with the apparatus 120. Various control buttons 125 permit the user to control the operation of the portable digital music player. The control buttons 125 may include a “record button”, such that the user may record their singing, a “microphone on button” such that the user can hear their singing through the headphones 55 while they are singing, “a playback button”, which plays back both the recorded digital real audio signal with the digital music file, and “a normal music button”, which plays a digital music file without recording or playback of a recorded real digital audio signal. Other control buttons that may be included would control normal operating functions of the portable digital music player, such as volume control; one/off button; forward and reverse buttons to permit the user to cycle through stored digital files; etc.

The apparatus 120 may also include an external stereo jack 130 such that the portable digital music player can be attached to an external stereo. This would permit the user to broadcast their recorded real audio digital signal with the digital music file over a stereo or karaoke machine. The portable digital music player would also include an interface jack (not shown) for connection with a personal computer such as a USB jack, and may include a means to attach a removable flash memory cartridge or a means to attach other external non-volatile memory devices.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A portable digital music player comprising:
a means for playing a digital music file that consists at least of an audio portion and a data portion;
a means for emitting the audio portion;
a means for displaying the data portion;
a means for recording a user's voice while the audio portion of the digital music file is being emitted by the emitting means; and
a means for synchronously replaying the recorded user's voice and the audio portion of the digital music file through the emitting means at a later time.

2. The portable digital music player of claim 1, further including a means for playing the user's voice through the emitting means with the audio portion of the digital music file while the user's voice is being recorded by the recording means.

3. The portable digital music player of claim 2, further including a means for uploading digital music files from an external source.

4. The portable digital music player of claim 3, wherein the means for recording includes a non-volatile memory.

5. The portable digital music player of claim 4, wherein the data portion of the digital music file are lyrics to a song, and the audio portion of the digital music file is said song without a singing portion.

6. The portable digital music player of claim 1, wherein the means for recording the user's voice includes:
a means for converting the user's voice from an analog signal to a digital signal;
a means for processing the digital signal;
a means for compression or formatting the digital signal into a digital user file; and
a means for storing the file in memory.

7. The portable digital music player of claim 6, wherein the means for synchronously replaying the recorded user's voice and the audio portion of the digital music file through the emitting means at a later time includes:
a means for retrieving the digital user file and the digital music file;
a means for decoding the digital user file into a digital signal and a means for decoding the digital music file into at least an audio portion;
a means for mixing the digital user file and the audio portion of the digital music file; and
a means for replaying the mixed digital user file and audio portion.

8. The portable digital music player of claim 1 further including a means for replaying only the recorded user's voice.

9. A portable digital music player comprising:
a means for playing a digital music file that consists at least of an audio portion;
a means for emitting the audio portion;
a means for recording a user's voice while the audio portion of the digital music file is being emitted by the emitting means; and
a means for synchronously replaying the recorded user's voice and the audio portion of the digital music file at a later time.

10. The portable digital music player of claim 9 further comprising a means for replaying only the recorded user's voice.

11. The portable digital music player of claim 10 further comprising a means for simultaneously emitting the user's voice through the emitting means, while the user's voice is being recorded.

12. The portable digital music player of claim 11, wherein the user's voice is recorded on a non-volatile memory.

13. The portable digital music player of claim 12, wherein the means for recording the user's voice include:
a means for converting and processing the user's voice into a digital signal;
a means for compressing the digital signal into a formatted digital signal; and
a means for storing the formatted digital signal on the non-volatile memory.

14. The portable digital music player of claim 12, wherein the means for synchronously replaying the recorded user's voice and the audio portion of the digital music file at a later time includes:
a means for retrieving the recorded user's voice from the non-volatile memory;
a means for retrieving the digital music file;
a means for mixing the recorded user's voice and the audio portion of the digital music file such that the recorded user's voice is synchronized with the audio portion.

15. A portable music player comprising:
a non volatile memory for storing and recording music files and, wherein at least one music file includes at least an audio portion and a data portion;
a display screen;
a headphone jack for receiving headphones;
a microphone jack for receiving an external microphone; and
a microprocessor having instructions for retrieving and decoding said one music file from the non volatile memory and instructions for playing the music file, wherein the instructions for playing the music file include instructions for displaying the data portion over the display screen simultaneously with emitting the audio portion over headphones that are received in the headphone jack, the microprocessor having further instructions for recording a user's voice, coming through an external microphone received in the microphone jack, simultaneously with the playing of the music file,
and the microprocessor having further instructions for synchronously replaying the recorded user's voice with said one music file at a later time.

16. The portable music player of claim 15, wherein the recorded user's voice is stored on the non volatile memory.

17. The portable music player of claim 16, wherein the microprocessor includes instructions for playing the user's voice over the headphones at the same time the microprocessor is recording the user's voice.

18. The portable music player of claim 17 wherein the music files are digital music files and the microprocessor includes instructions for decoding the digital music files.

19. The portable music player of claim 18 further includes a converter for converting the user's voice into a digital signal and the microprocessor includes instructions for compressing the digital signal prior to recording the digital signal on the non-volatile memory.

20. The portable music player of claim 19, wherein the user's voice is recorded in real time.
